(19) United States
(12) Patent Application Publication
(10) Pub. No.: US 2024/0061112 A1
(43) Pub. Date: Feb. 22, 2024

(54) Quantum Detection and Ranging System and Related Methods

(71) Applicant: Naval Information Warfare Center Pacific, San Diego, CA (US)

(72) Inventors: Joanna Ptasinski, San Diego, CA (US); Melvin Pascoguin, San Diego, CA (US)

(73) Assignee: THE UNITED STATES OF AMERICA AS REPRESENTED BY THE SECRETARY OF THE NAVY, San Diego, CA (US)

(21) Appl. No.: 17/892,572

(22) Filed: Aug. 22, 2022

(51) Int. Cl. G01S 17/08; G01S 7/481

(52) U.S. Cl. CPC G01S 17/08; G01S 7/4814; G01S 7/4816

(57) ABSTRACT

The present invention relates to a quantum radar system for using entangled photons to detect and range objects. According to an illustrative embodiment of the present disclosure, an entangled photon source generates at least one group of entangled photons each comprising at least one signal photon and an idler photon. The entangled photon source directs the at least one signal photon toward an object of interest and the idler photon towards a slow light section comprising a slow light material. The idler photon passes through the slow light section and continues to a photon detector. The at least one entangled photon reflects off of the objection of interest and continues to the detector.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 210762) is assigned to the United States Government and is available for licensing for commercial purposes. Licensing and technical inquiries may be directed to the Office of Research and Technical Applications, Naval Information Warfare Center Pacific, Code 72120, San Diego, CA, 92152; voice (619) 553-5118; ssc_pac_t2@navy.mil.

### BACKGROUND OF THE INVENTION

Radar systems detect and range an object by reflecting radio waves off of the object and detecting the reflected radio waves. When conventional radar system attempt to detect objects, the radio waves may be scattered so that instead of bouncing straight back to the sender, they bounce off in a different direction which causes for a considerably lower count of photons to arrive at the detector and uncertainty as to whether those photons are the actual photons that were sent by the system or stray photons (i.e. noise). In addition, conventional radar systems need to use a large number of photons to reliably detect and range which crowds the spectrum with noise. A detection and ranging system is needed that can reliably detect and range an object without returning false positives.

### SUMMARY OF THE INVENTION

The present invention relates to a quantum radar system for using entangled photons to detect and range objects.

According to an illustrative embodiment of the present disclosure, an entangled photon source generates at least one group of entangled photons each comprising at least one signal photon and an idler photon. The entangled photon source directs the at least one signal photon toward an object of interest and the idler photon towards a slow light section comprising a slow light material. The idler photon passes through the slow light section and continues to a photon detector. The at least one entangled photon reflects off of the objection of interest and continues to the detector.

According to a further illustrative embodiment of the present disclosure, a quantum radar system can be used to range and detect objects of interest. Exemplary methods include generating a plurality of entangled photons comprising an idler photon and at least one signal photon, directing the idler photon towards a slow light section and the at least one signal photon towards an object of interest, directing the idler photon from the slow light section to a photon detector, and detecting the idler photon and any received signal photon of the at least one signal photon.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

Throughout the several views, like elements are referenced using like references. The elements in the figures are not drawn to scale and some dimensions are exaggerated for clarity.

The detailed description of the invention particularly refers to the accompanying figures in which:

FIG. 1 shows an exemplary quantum radar system.

FIG. 2 shows an exemplary quantum radar system utilizing a synchronization feedback loop.

FIG. 3 shows an exemplary method for ranging and detecting using a quantum radar system.

### DETAILED DESCRIPTION OF THE INVENTION

The embodiments of the invention described herein are not intended to be exhaustive or to limit the invention to precise forms disclosed. Rather, the embodiments selected for description have been chosen to enable one skilled in the art to practice the invention.

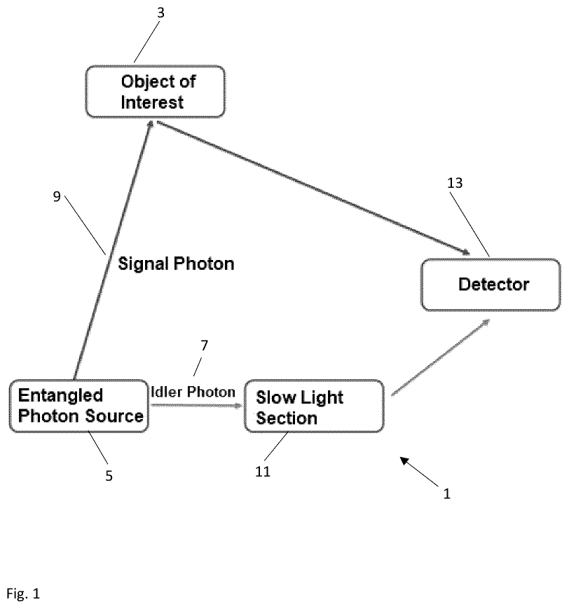

FIG. 1 shows an exemplary quantum radar system 1 used to detect and range an object of interest 3. An entangled photon source 5 generates an idler photon 7 and at least one signal photon 9. The idler photon 7 is directed towards a slow light section 11 designed to delay the idler photon before passing it to detector 13. The at least one signal photon 9 is directed towards the object of interest 3 such that the signal photon can be reflected off of the object of interest. If the optical paths of the idler photon 7 and at least one signal photon 9 match, the detector will receive both photon types simultaneously. Because the optical path of the idler photon 7 is known, the optical path length of the at least one signal photon 9 can be calculated which can then be used to determine the distance between the system 1 and object of interest 3. To create compact systems, the distance between the entangled photon source 5 and the detector 13 should be vastly shorter than the distance between the system 1 and object of interest 3. In addition, the system 1 should be able to detect objects of interest 3 at a variety of distances. To meet both of these objectives, slow light section 11 can include a tunable slow light material (e.g., controlled adjustments to the group velocity of the idler photon by tuning the index of refraction) which can slow down the idler photon 7 by a known amount so that the delay can be calculated.

Exemplary systems can use a variety of photon sources 5. Exemplary photon sources 5 include spontaneous parametric down conversion based nonlinear crystals such as silicon nitride, BiBO, beta-Barium Borate (BBO), KTP, LBO, Nd:YVO4, YVO4, LiIO3, DKDP, KDP, and ADP, or through quantum dots and periodically poled lithium niobate (PPLN) waveguides. When generating three or more photons, it is preferable to allocate more photons as signal photons 9 than idler photons 7 because signal photons are much less likely to reach the detector 13 as a result of random scattering. Maximizing the number of signal photons of the at least one signal photon 9 increases the likelihood that the detector 13 will successfully receive one of the signal photons. However, given the current state of the art, it is unlikely that more than three signal photons (four photons total) can be reliably created by a single photon source. If multiple systems 1 or photon sources 5 are used to generate more photons, the photon from separate systems or sources will not be entangled with each other.

The photon source 5 also has inherent limits on the rate at which entangled photons can be produced. Typically used photon sources 5 can produce entangled photons at a rate of 65 000 pairs/s/mW. Multiple systems 1 or photon sources 5 can operate in tandem to increase photon production, but keeping the photon intensity low can be preferable in certain operating environment. For example, low photon intensity can be safer as higher energies may harm people or equipment in the operating environment. In addition, low photon intensity can be beneficial for maintaining a smaller spectral footprint. If a higher intensity is desired, an operator can add additional systems 1 or photon sources 5 until the desired photon generation capacity is reached. For systems in which a plurality of photon sources 5 are used, a corresponding plurality of slow light sections 11 can be used such that photons from each photon source can be separately tuned. The photon source 5 can generate photons at a variety of wavelengths. Common wavelengths are 1550 nm and 810 nm. 1550 nm has low atmospheric propagation losses, but the accompanying optics at this wavelength can be more inefficient. 810 nm has slightly higher atmospheric propagation losses, but sources and detectors at this wavelength are much more common, developed, and efficient.

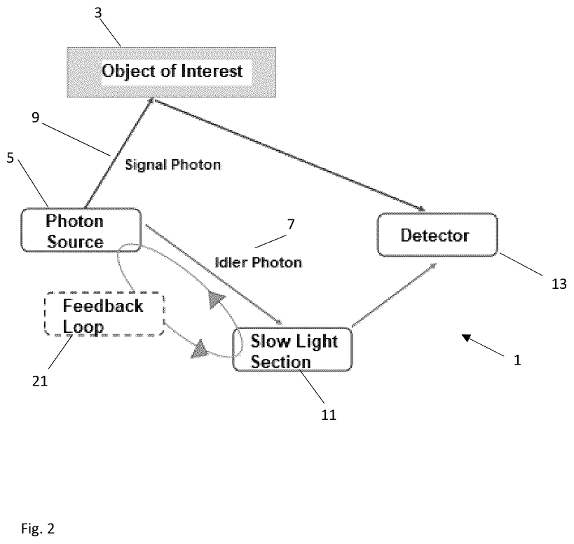

FIG. 2 shows an exemplary quantum radar system utilizing a synchronization feedback loop. In any given iteration, the photon source creates entangled photons, the photons are directed towards their intended targets, and the photons are received by the detector. In a single iteration, it is highly unlikely that the idler and signal optical path lengths will match. As such, the system needs to cycles through a plurality of idler optical path lengths until a match is detected. To accomplish this, the slight light section can be tuned with a slight variation such that the idler optical path length is different in each iteration of the feedback loop.

Exemplary systems can use any suitable slow light materials. In an exemplary system, the slow light material of slow light section 11 can be a gas mixture (e.g., rubidium gas) within a gas cell, photonic crystals, metamaterials or metamaterial inserts (e.g., silicon waveguides with metamaterial inserts), and Bose-Einstein condensates. Slow light materials can be selected based on a variety of factors such as operating temperature, high refractive index, cost, etc., or a combination of these factors. For example, Bose-Einstein condensates have a high refractive index and can therefore easily slow down light, but because temperatures near absolute zero are required, they may be difficult to use in practice at these temperatures. In contrast, slow light materials that can operate at room temperature (e.g., photonic crystals, metamaterials, room temperature rubidium gas cells, etc.) are easier to use without necessarily sacrificing a high refractive index (e.g., rubidium gas cells). Slow light materials should also be selected for high photon coherence. If the photon propagates through a uniform, isotropic medium it is expected to maintain its coherence (i.e. polarization state). If the photon were to propagate through a birefringent medium, such as calcite, over time the polarization state would randomly rotate and deviate from vertical (i.e. the photon would decohere). If a linearly polarized laser beam propagates through a birefringent medium, there are generally two polarization components with different wavenumbers. Therefore, the optical phases of the two linear polarization components evolve differently, and consequently the resulting polarization state caused by the superposition of the two components changes during propagation. If the idler photon 7 and at least one signal photon 9 decohere, the detector 13 will not be able to correlate them. Exemplary systems can work best by using isotropic slow light materials that are tunable/adjustable over a large range of refractive indices.

Exemplary systems can use any suitable tuning methods available (e.g., thermal, optical, electrical, magnetic, etc.). For example, thermal tuning is effective and efficient for rubidium gas cells. Various metamaterials (e.g., metamaterials with liquid crystals) could use thermal or electric tuning. To thermally tune, the temperature of the slow light section can be adjusted by a heat source. To electrically tune, electrodes can apply a current. To optically tune, a laser source can be directed through a liquid crystal medium to align the direction of the medium's index of refraction.

A variety of feedback loop methodologies can be used to establish the range of an object. In exemplary methodologies, the system or a user can generate a starting value (r) for the range. The starting value can be an estimate of the distance to the object, or it can be independent from any operational conditions (e.g., the median value of the system's operating range). The feedback loop can then tune the tunable medium to cycle through a plurality of values around the starting value. In exemplary methodologies, the feedback loop alternate between increasing and decreasing values centered at the starting value (e.g., the series 100, 101, 99, 102, 98, etc.) where R is the range distance scanned, an integer n representing the number of the cycle starting at n=0, and a constant C representing the tuning variation. Using a smaller C value will increase the reliability and accuracy of the system but also increase the time needed to find the correct range. In exemplary methodologies, the feedback loop can incrementally adjust the scanning distance in a single direction beginning with the starting value, where C is positive to increase the scan distance and C is negative to decrease the scan distance. The preferred feedback loop algorithm may depend on the mechanism used to tune the slow light material. For example, operators may prefer the single direction method for systems that use thermal tuning because it may be difficult to rapidly alternate the temperature of the slow light material, while steadily increasing or decreasing the temperature is easier and more efficient.

For embodiments in which a plurality of systems 1 or photon generators 5 are used in tandem, feed loop methodologies can utilize the additional photon generation to measure scan separate distances. For example, with two photon generators 5 and two corresponding slow light sections 11, each slow light section can tune the idler photons 7 to start at a central starting value (e.g., a predetermined range median or an estimated target distance value), then the first slow light section can adjust the refractive index in a positive direction while the second slow light section can adjust the refractive index in a negative direction. In an alternative example with two photon generators 5 and two corresponding slow light sections 11, each slow light section can tune the idler photons 7 to start at separate starting values representing opposing bounds of the scanning range, then the first slow light section can adjust the refractive index in a positive direction while the second slow light section can adjust the refractive index in a negative direction such that the tuned values eventually meet in the middle.

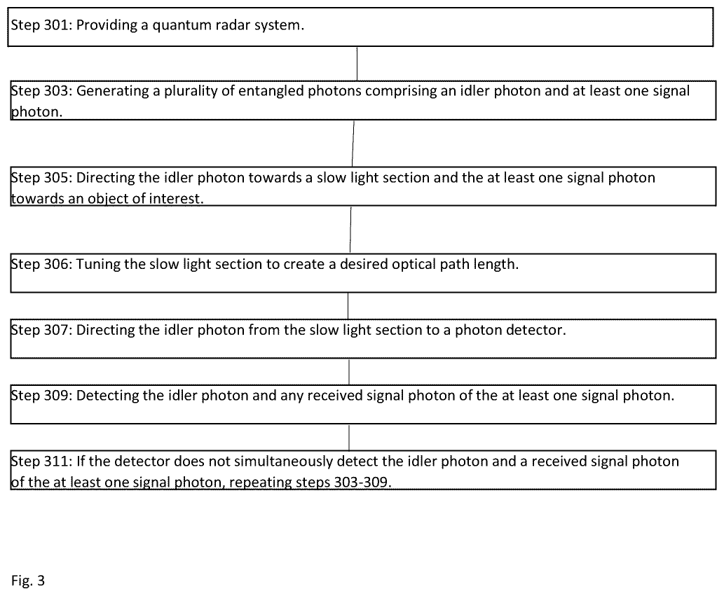

FIG. 3 shows an exemplary method for ranging and detecting using a quantum radar system. At step 301, providing a quantum radar system. At step 303, generating a plurality of entangled photons comprising an idler photon and at least one signal photon. At step 305, directing the idler photon towards a slow light section and the at least one signal photon towards an object of interest. At step 307, directing the idler photon from the slow light section to a photon detector. At step 309, detecting the idler photon and any received signal photon of the at least one signal photon. At step 311, if the detector does not simultaneously detect the idler photon and a received signal photon of the at least one signal photon, repeating steps 303-309. Exemplary methods can include step 306, tuning the slow light section to create a desired refractive index. Upon repeating steps 303-309, a higher or lower refractive index can be selected.

Although the invention has been described in detail with reference to certain preferred embodiments, variations and modifications exist within the spirit and scope of the invention as described and defined in the following claims.

1. A quantum radar system comprising:
at least one entangled photon source configured to generate at least one group of entangled photons each comprising at least one signal photon and an idler photon;
a slow light section comprising a slow light material; and
a photon detector;
wherein the at least one entangled photon source is configured to directs the at least one signal photon toward an object of interest and the idler photon towards the slow light section;
wherein the slow light section directs the signal photon towards the photon detector.

2. The system of claim 1, wherein the slow light material comprises a material with an adjustable refractive index.

3. The system of claim 2, wherein the slow light section is configured to adjust the refractive index using a tuning mechanism.

4. The system of claim 3, wherein the slow light material comprises rubidium vapor.

5. The system of claim 3, wherein the slow light material comprises metamaterials.

6. The system of claim 3 wherein the slow light material comprises a non-linear photonic crystal.

7. The system of claim 1 wherein the at least one entangled photon source comprises a non-linear crystal.

8. The system of claim 1 wherein the at least one entangled photon source comprises a first and second entangled photon source.

9. A method for detecting and ranging comprising:
(a) providing at least one quantum radar system;
(b) generating a plurality of entangled photons comprising an idler photon and at least one signal photon;
(c) directing the idler photon towards a slow light section and the at least one signal photon towards an object of interest;
(d) directing the idler photon from the slow light section to a photon detector;
(e) detecting the idler photon and any received signal photon of the at least one signal photon.

10. The method of claim 9, further comprising:
(cc) after step (c), tuning the slow light section to create a desired refractive index within the slow light section;
(f) if the detector does not simultaneously detect the idler photon and a received signal photon of the at least one signal photon, repeating steps (a) through (e).

11. The method of claim 10, wherein step (cc) comprises increasing or decreasing the refractive index within the slow light section by a predetermined amount.

12. The method of claim 10, wherein step (cc) comprises alternating increasing and decreasing the refractive index within the slow light section by a increasing predetermined amounts.

13. A method for detecting and ranging comprising
(a) providing at least one quantum radar system comprising:
at least one entangled photon source configured to generate at least one group of entangled photons each comprising at least one signal photon and an idler photon;
a slow light section comprising a slow light material; and
a photon detector;
(b) generating a plurality of entangled photons comprising an idler photon and at least one signal photon;
(c) directing the idler photon towards a slow light section and the at least one signal photon towards an object of interest;
(d) directing the idler photon from the slow light section to a photon detector;
(e) detecting the idler photon and any received signal photon of the at least one signal photon.
